(19) United States
(12) Patent Application Publication
(10) Pub. No.: US 2013/0037508 A1
(43) Pub. Date: Feb. 14, 2013

(54) PREFORM WITH INSERT RING, CONTAINER, AND METHOD

(71) Applicants: Marc A. Pedmo, Litchfield, OH (US); Robert A. McIntire, Fayetteville, GA (US)

(72) Inventors: Marc A. Pedmo, Litchfield, OH (US); Robert A. McIntire, Fayetteville, GA (US)

(73) Assignee: PLASTIPAK PACKAGING, INC., Plymouth, MI (US)

(21) Appl. No.: 13/569,960

(22) Filed: Aug. 8, 2012

Related U.S. Application Data
(60) Provisional application No. 61/522,964, filed on Aug. 12, 2011.

(51) Int. Cl. B65D 1/46; B29C 69/00

(52) U.S. Cl. 215/42; 264/152

(57) ABSTRACT

A preform includes a closed lower portion; a sidewall portion extending upwardly from the closed lower portion; an upper neck portion extending upwardly from the sidewall portion; and an insert ring. In embodiments, a portion of the upper neck portion is formed around at least a portion of the insert ring. Further, with embodiments, the insert ring may be multi-layered, and may include a first layer including a polymer, and a second layer including an additional material. Embodiments of such preforms may be molded into various forms of plastic containers.

### CROSS-REFERENCE TO RELATED APPLICATION

This application claims the benefit of priority to U.S. Provisional Application No. 61/522,964, filed Aug. 12, 2011, the entire disclosure of which is incorporated herein by reference.

### TECHNICAL FIELD

The present invention relates generally to preforms and plastic containers made from preforms, including preforms having an insert.

### BACKGROUND

Plastic containers formed from preforms are known in the field. Various conventional preforms attempt to incorporate barriers and/or oxygen scavengers, commonly in an effort to improve the shelf life associated with container contents. In many cases, the inclusion of barriers, such as catalytic barriers, can be complex and may require coordination with other components, such as a specialized closure or complex resin processing. For example, in some two-part systems, a catalyst may be added to the sidewall of a container and an activator may be added to the container closure. In other two-part systems, both a catalyst and an activator may be added to the container closure.

However, for among other things, providing a preform and container that simplifies the process, such as by providing a single-component solution, and still provides a commercially acceptable container is desirable.

### SUMMARY

A preform is disclosed that includes a closed lower portion; a sidewall portion extending upwardly from the closed lower portion; an upper neck portion extending upwardly from the sidewall portion; and an insert ring. In embodiments, a portion of the upper neck portion is formed around at least a portion of the insert ring. Further, in connection with some embodiments, the insert ring may be multi-layered, and may include a first layer including a polymer, and a second layer including an additional material. Embodiments of such preforms may be molded into various forms of plastic containers.

### BRIEF DESCRIPTION OF THE DRAWINGS

Embodiments of the invention will now be described, by way of example, with reference to the accompanying drawings, wherein:

FIG. 1 is a side elevation view of an embodiment of a preform;

FIG. 2 is a side elevation view of an embodiment of a container;

FIG. 3 is a perspective view of an embodiment of a multi-layer tube;

FIG. 4 is a side elevation view of an embodiment of a multi-layer tube;

FIG. 5 is a side perspective view of an embodiment of a multi-layer insert ring;

FIG. 6 is a side view of an embodiment of an insert ring being positioned for insertion onto a core pin;

FIG. 7 is a side perspective view of an embodiment of a core pin with a step portion; FIGS. 7A to 7C additionally illustrate features associated with a core pin;

FIG. 8 is a side perspective view of an embodiment of a polymer formed over an insert ring; and

FIG. 9 is a side perspective view generally illustrating an embodiment of an insert ring provided on an inner surface of a preform.

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

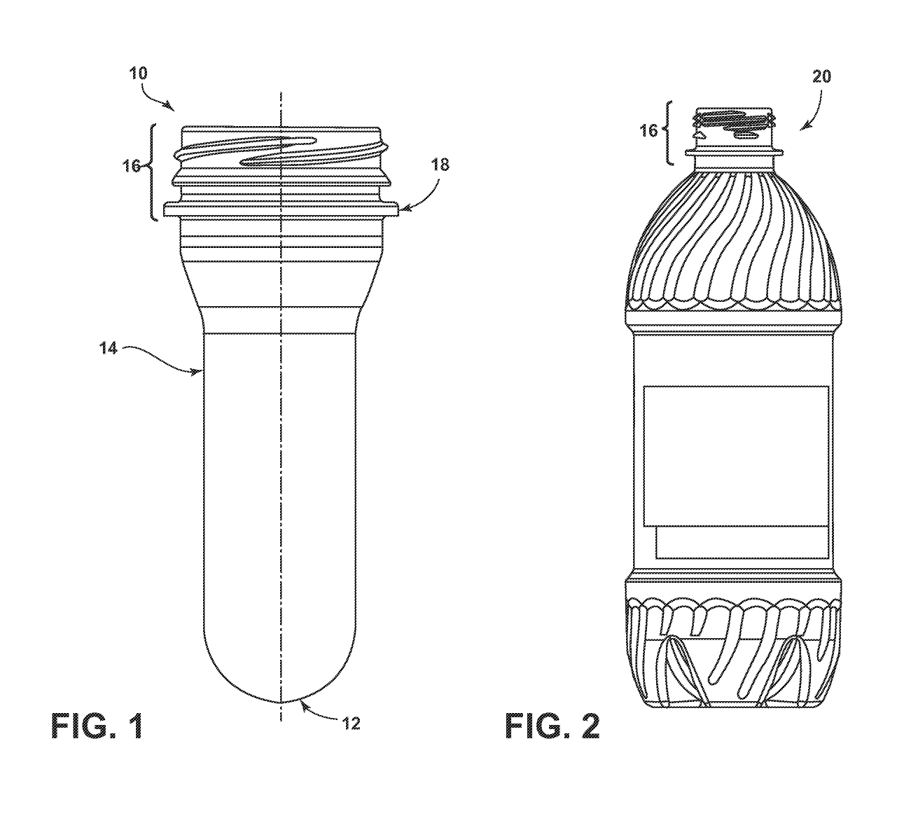

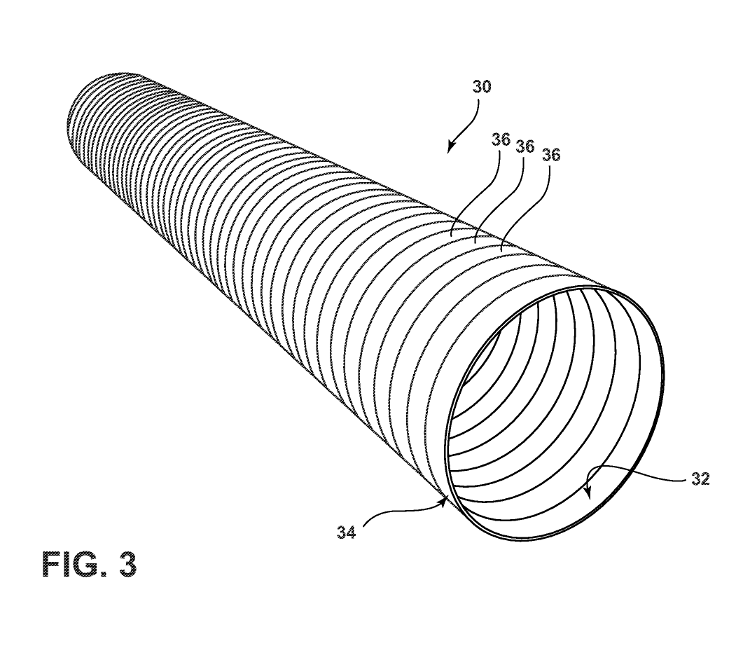

An embodiment of a preform 10 is generally illustrated in FIG. 1. The preform generally includes a closed lower portion 12; a sidewall portion 14 extending upwardly from the closed lower portion 12; and an upper neck portion 16 extending upwardly from the side wall portion 14. In an embodiment, such as generally illustrated, the upper neck portion 16 may include a flange portion 18. An embodiment of a container 20 that may be formed from a preform, such as illustrated in FIG. 1, is generally illustrated in FIG. 2. In embodiments, the upper neck portion 16′ of the formed container 20 can have substantially similar dimensions as the upper neck portion 16 of the preform used to form the container.

FIG. 3 generally illustrates a perspective view of an embodiment of a multi-layer tube 30 formed in accordance with teachings of the present disclosure. As generally illustrated, the tube 30 may include at least an inner layer 32 and an outer layer 34. In embodiments, the inner layer 32 may comprise a polymer, and the outer layer 34 may comprise a polymer and/or an additional (e.g., specialized) material. The additional material may, for instance, comprise a catalyst. By way of example, without limitation, inner layer 32 may comprise low-density polyethylene (LDPE), which may serve as a release regulator, and outer layer 34 may comprise LDPE and a catalyst. It is noted that for some embodiments, moisture could be required to initiate a reaction. Without limitation, in an embodiment, the inner layer 32 may, for example, have a thickness of about 0.02 inches, and the outer layer 34 may, for example, have a thickness of about 0.02 inches. However, with embodiments, the outer layer 34 of the insert ring may have one or more different material components in addition to, or instead of, a catalyst. For example, and without limitation, the insert ring (and in many instances just the outer layer) may be configured to include one or more of the following structures/features (which may be included in the form of an additional material):
oxygen scavenger and/or an oxygen scavenging additive
barrier and/or oxygen barrier
carbon dioxide generator
flavor additive
scent generating additive
vitamins or nutrients
radio frequency identification (RFID)-type insert
oxygen detector (e.g., changes color if exposed to oxygen for a period of time—in the nature of a “freshness” gauge)
color coding (configured to change color under relevant conditions—e.g., to provide a shelf life alert)
temperature (cold or heat) detector
strength enhancer/deformation resistance
sealing function (e.g. with respect to a closure feature)
provides a contact that is colder than the surrounding polymeric material (e.g., the ring material may be configured to touch a user's lips)
anti-counterfeiting feature (a feature that is difficult to emulate or imitate)

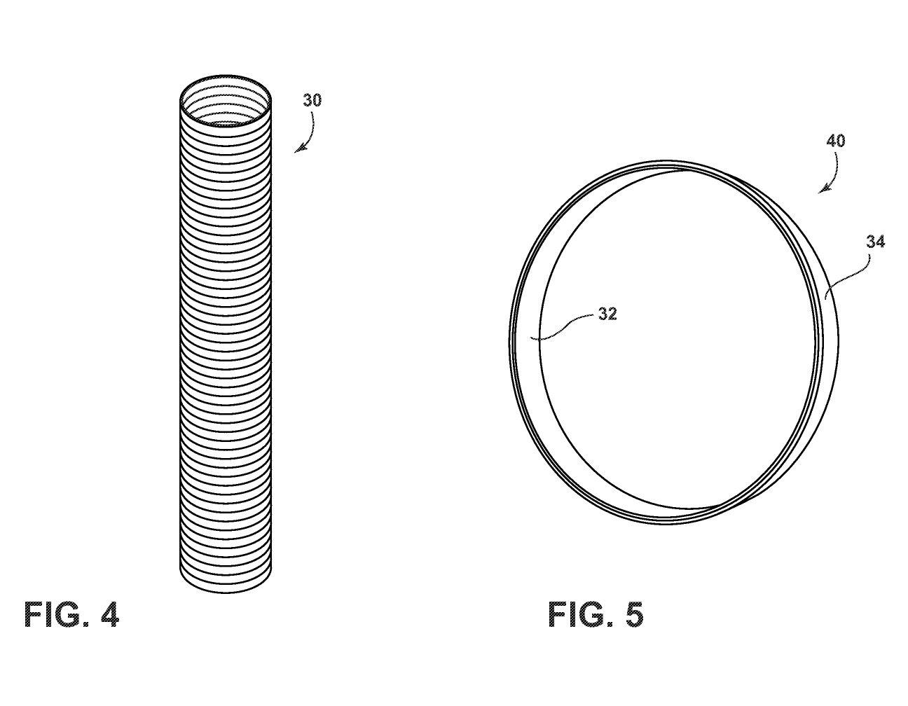

The tube may additionally include a plurality of ridges or grooves (e.g., separation grooves 36). Such ridges or grooves may be configured to indicate or delineate separation points or regions associated with the tube for forming (e.g., cutting or severing) a plurality of insert rings. For example, ultrasonic cutting may be employed to separate insert rings at or about separation points or regions associated with a tube. In embodiments, such as generally shown, the ridges or grooves may be continuous such that they encircle the outer periphery of the tube 30. However, for some embodiments, one or more of the ridges or grooves may not be completely continuous and may instead be formed to be discontinuous or intermittent. A side elevation view of an embodiment of a multi-layer tube 30 including a plurality of ridges or grooves is shown in FIG. 4.

An embodiment of a multi-layer insert ring 40 is generally shown in FIG. 5. The illustrated insert ring 40 includes an inner layer 32 and an outer layer 34. However, for some embodiments additional layers, such as a tie or binding layer, may also be included. Furthermore, with some embodiments, the insert ring 40, and a corresponding tube 30, may comprise a single layer (referred to as a “monolayer”).

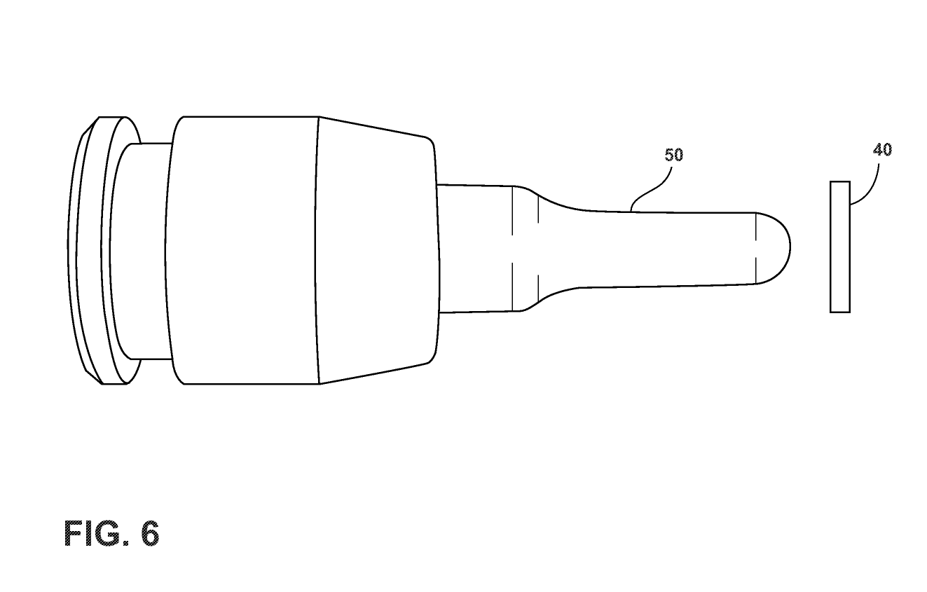

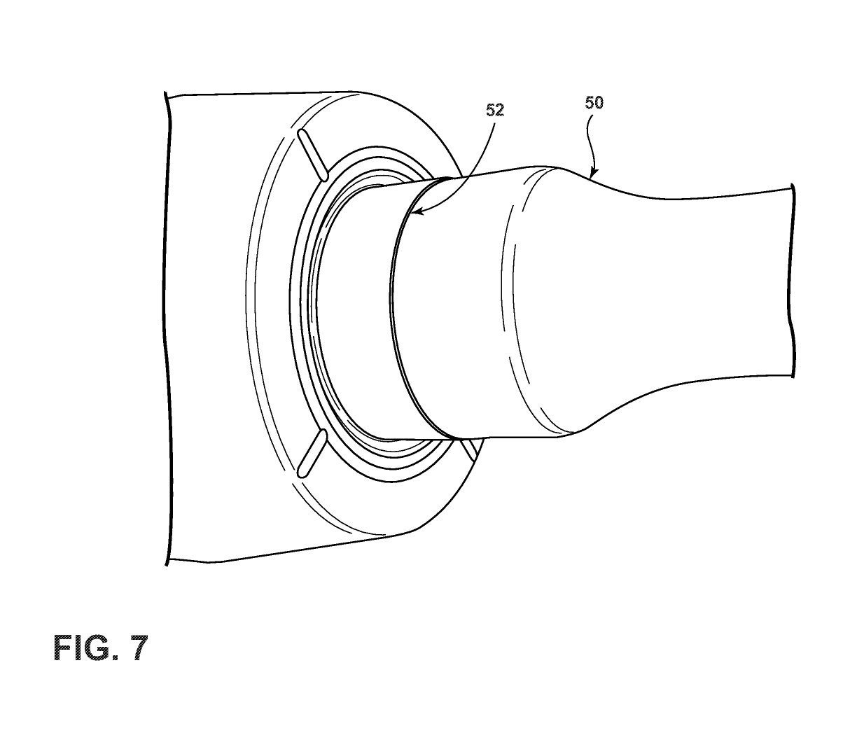

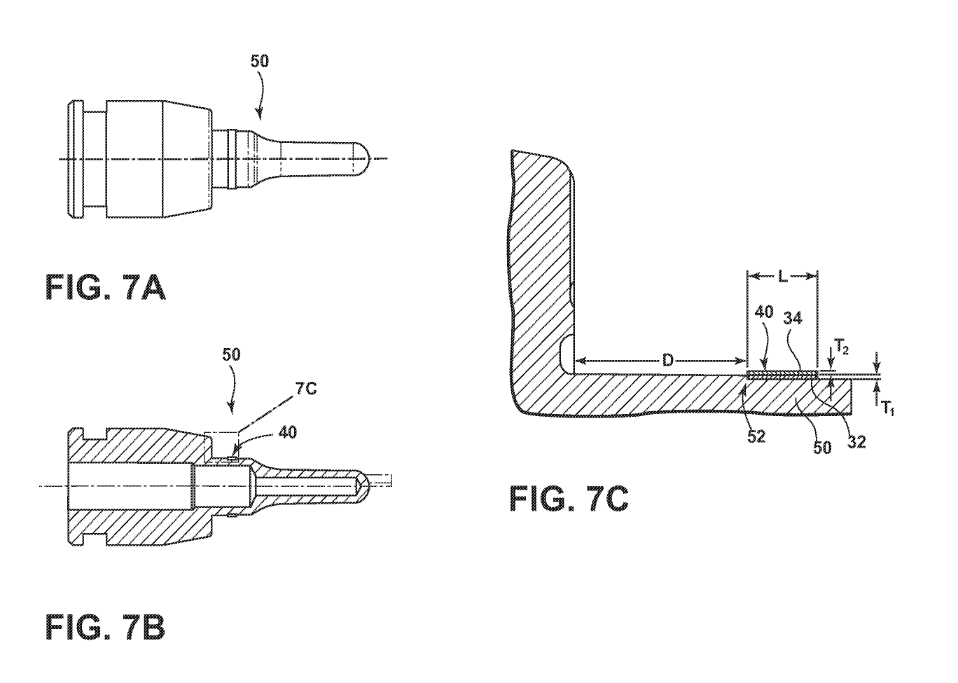

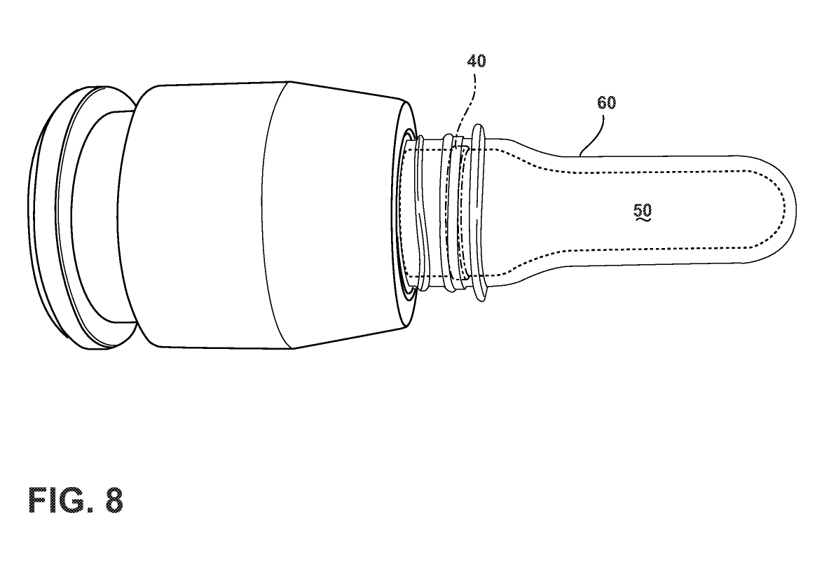

FIG. 6 illustrates an embodiment of an insert ring 40 generally positioned for insertion onto a core pin 50. Such a core pin may, for instance, be comprised of a highly polished stainless steel. As generally shown in FIG. 7, a core pin 50 can be configured to include a step portion 52, and the step portion can be configured to serve as a stop for an insert ring. FIGS. 7A through 7B generally illustrate certain features that may be associated with a core pin.

Turning to FIGS. 7B and 7C, an embodiment of a core pin 50, such as an injection core pin, is shown with a multi-layer insert ring 40. An enlarged view of the segment designated is shown in FIG. 7C. In embodiments, the step portion 52 height may be configured to be the same or substantially the same as the height (i.e., thickness) of the inner layer (e.g., inner layer 32) of the insert ring 40. Such a configuration may, among other things, serve to protect the inner layer 32—for instance, to provide for a slower release. In an embodiment, such as generally illustrated in FIG. 7C, a multi-layer insert ring 40 may be provided a distance D along a core pin 50, and the insert ring 40 may have a length L; an inner layer 32 having a thickness T₁, and an outer layer 34 having a thickness T₂. By way of example, and without limitation, in an embodiment distance D may be about 0.375 inches; length L may be about 0.151 inches; thickness T₁ may be about 0.010 inches; and thickness T₂ may be about 0.010 inches. In still other embodiments, distance D may be at or about 0.00 inches so as to be at or about the upper end of upper neck portion 16. Additionally, for some embodiments, the indicated length L may be about 0.25 inches, about 0.50 inches, about 1.00 inch, or more.

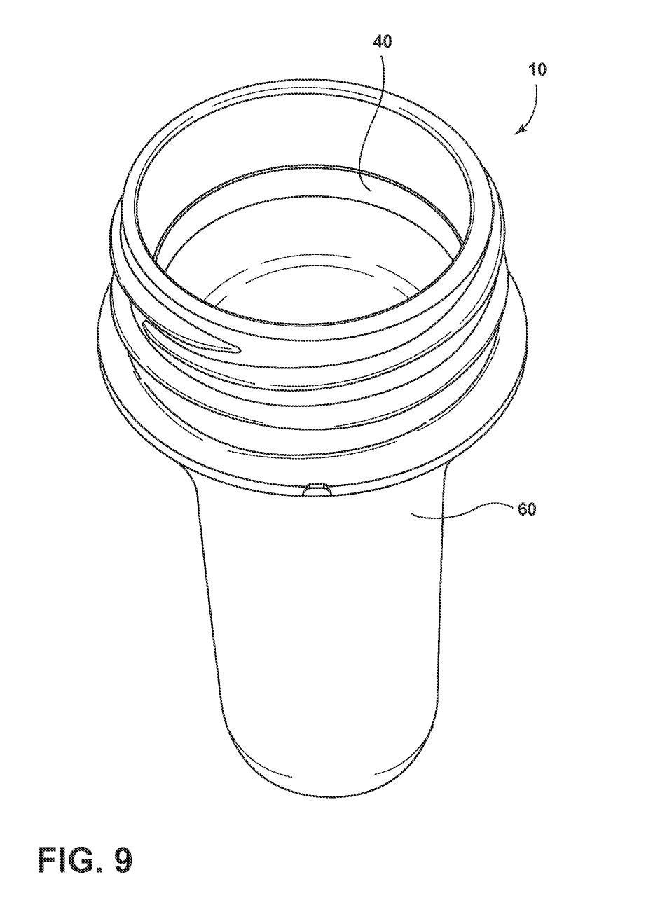

FIG. 8 generally illustrates a side perspective view of an embodiment in which a polymer 60 has been formed (e.g., injection molded) over an insert ring 40 on a core pin 50, to form a preform 10. For some embodiments the insert ring 40 can be limited to being provided in the upper neck portion 16. For other embodiments, the insert ring may enter into at least a portion of the sidewall portion 14. Moreover, with some embodiments, an inner radial portion of a multi-layer insert ring (which may, for example, comprise an innermost layer of the insert ring) can be exposed on the inner surface of the preform. Such a preform 10, which may be of the type generally illustrated in FIG. 9, can then be blow molded into a container, for example, utilizing a conventional injection stretch blow molding process.

A method as generally described above may be used to form containers having an insert ring that can serve various intended commercial purposes. Notably, insert rings of the type taught herein may be used in connection with heat set technologies, including heat set neck finishes, as well as with various barrier technologies. For example, an insert ring comprised of polypropylene might be configured to withstand high filing temperatures (e.g., 205° of more). Further, methods can be employed during the recycling process to separate or segregate materials associated with insert rings from materials associated with the remainder of the preforms or containers.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims appended hereto and their equivalents.

What is claimed is:

1. A preform comprising:
a closed lower portion;
a sidewall portion, the sidewall portion extending upwardly from the closed lower portion,
an upper neck portion, the upper neck portion extending upwardly from the sidewall portion; and
an insert ring;
wherein a portion of the upper neck portion is formed around at least a portion of the insert ring.

2. The preform of claim 1, wherein the insert ring is solely provided in the upper neck portion of the preform.

3. The preform of claim 1, wherein the insert ring is a multi-layer insert ring.

4. The preform of claim 3, wherein the multi-layer insert ring includes a first layer including a polymer, and a second layer including an additional material.

5. The preform of claim 4, wherein the first layer is an inner layer, and the second layer is an outer layer.

6. The preform of claim 4, wherein the additional material comprises a catalyst.

7. The preform of claim 4, wherein the additional material comprises an oxygen scavenger or oxygen scavenging additive.

8. The preform of claim 4, wherein the additional material comprise a barrier.

9. The preform of claim 8, wherein the barrier is an oxygen barrier.

10. The preform of claim 4, where in the additional material comprises a carbon dioxide generator, flavor additive, scent generating additive, vitamin, nutrient, RFID insert, oxygen detector, color coding, or temperature detector.

11. The preform of claim 4, wherein second layer includes a polymer, and the polymer of the first layer and the polymer of the second layer are the same.

12. The preform of claim 6, wherein the catalyst comprises about four percent (4%) or less of the content volume of the second layer.

13. The preform of claim 1, wherein the insert ring is comprised of low-density polyethylene (LDPE) or polypropylene (PP).

14. The preform of claim 1, wherein the upper neck portion formed around the insert ring is comprised of polyethylene terephthalate (PET).

15. The preform of claim 1, wherein the insert ring comprises three or more layers.

16. The preform of claim 1, wherein the insert ring includes a tie or binding layer.

17. The preform of claim 1, wherein an inner radial portion of the insert ring is exposed on the inner surface of the preform.

18. A molded plastic container comprising:
a closed lower portion configured to support the container on a surface;
a sidewall portion, the sidewall portion extending upwardly from the closed lower portion,
an upper neck portion, the upper neck portion extending upwardly from the sidewall portion; and
an insert ring;
wherein a portion of the upper neck portion is formed around at least a portion of the insert ring.

19. The container of claim 18, wherein the insert ring is a multi-layered insert ring.

20. The container of claim 19, wherein the multi-layer insert ring includes a first layer including a polymer, and a second layer including an additional material.

21. The container of claim 18, wherein the insert ring is solely provided in the upper neck portion of the container.

22. A method for forming a preform with an insert ring, the method comprising:
providing a tube;
cutting or severing portions of the tube to provide a insert ring;
providing the insert ring onto a core pin; and
forming a polymer layer around the insert ring to form a preform, the preform having an upper neck portion;
wherein a portion of the upper neck portion is formed around at least a portion of the insert ring.

23. The method of claim 22, wherein the insert ring is a multi-layer insert ring.

24. The method of claim 22, wherein the core pin includes a step portion.
